(19) United States
(12) Patent Application Publication
(10) Pub. No.: US 2010/0101875 A1
(43) Pub. Date: Apr. 29, 2010

(54) Power Supply Device And Electric Vehicle Incorporating Said Device

(75) Inventor: Yoshihiko MAEDA, Kasai City (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Osaka (JP)

(21) Appl. No.: 12/604,056

(22) Filed: Oct. 22, 2009

(30) Foreign Application Priority Data
Oct. 24, 2008 (JP) 2008-274677

(51) Int. Cl. B60K 1/00; B60L 1/00

(52) U.S. Cl. 180/65.1; 307/80; 307/9.1

(57) ABSTRACT

To provide a power supply device and an electric vehicle in which variation in the respective remaining capacities among a plurality of power storage devices can be reduced, a power supply device sets a connecting time period for electrically connecting two power storage devices among a plurality of power storage devices 10A to 10C based on voltages V_{SA} to V_{SC} detected at a plurality of voltage detection units 42A to 42C.

### CROSS REFERENCE TO RELATED APPLICATIONS

This application claims priority under 35 USC 119 from prior Japanese Patent Application No. P2008-274677 filed on Oct. 24, 2008, the entire contents of which are incorporated herein by reference.

### BACKGROUND OF THE INVENTION

1. Field of the Invention

The present invention relates to a power supply device having a plurality of power storage devices connected in parallel. The present invention also relates to an electric vehicle that incorporates such power supply device.

2. Description of Related Art

A power supply device having a plurality of power storage devices connected in parallel is generally known for achieving high energy storage capacity and high power output. Such a power supply device is used for example in an electric vehicle.

For each such power storage device, a current allowed to flow through the power storage device (hereinafter referred to as an “allowable current”) is established. If the current that flows through the power storage device exceeds the allowable current due to for example variation or change in the internal resistance of each power storage device, deterioration of the power storage device becomes accelerated due to the self-heating of the power storage device.

Thus, technology was proposed in which a current that flows through each power storage device is controlled such that the current that flows through each power storage device does not exceed the allowable current. See e.g. Japanese Patent Laid-Open No. 2008-118790.

More precisely, the power supply device has a current distribution unit connected in series to the power storage device. The current distribution unit controls the current that flows through the power storage device by changing a resistance value of a resistance provided in the current distribution unit.

However, since the current that flows through each power storage device differs, variation occurs in the remaining capacity at each power storage device. Since the capacity of the whole power supply device (available time) is exhausted at the time when the capacity of one power storage device is exhausted, there was a problem in that if variation occurs in the remaining capacity of each power storage device, the operating life duration of the power supply device as a whole is reduced.

Therefore, an object of the invention is to solve the above-described problems and to provide a power supply device and an electric vehicle incorporating the power supply device, which can reduce variation among the respective remaining capacities of a plurality of power storage devices.

### SUMMARY OF THE INVENTION

One aspect of the invention relates to a power supply device having a plurality of power storage devices connected in parallel with each other, which includes a plurality of temperature detection units for respectively detecting temperatures of the plurality of power storage devices; a plurality of voltage detection units for respectively detecting voltages applied to the plurality of power storage devices; switch elements respectively connected in series with the plurality of power storage devices; and a control unit for controlling the ON and OFF states of the plurality of switch elements based on temperatures detected at the plurality of temperature detection units; in which the control unit sets a connecting time period for electrically connecting two power storage devices among the plurality of power storage devices based on the voltages detected at the plurality of voltage detection units.

In the power supply device according to the feature of the invention, the control unit may compute the connecting time period per unit time based on a voltage difference of the two power storage devices and a predetermined amount of current that does not affect temperatures of the plurality of power storage devices.

In the power supply device according to the feature of the invention, a voltage of one of the two power storage devices may be the lowest voltage among the respective voltages of the plurality of power storage devices.

In the power supply device according to the feature of the invention, a voltage of one of the two power storage devices may be the highest voltage among the voltages of the plurality of power storage devices.

In the power supply device according to the feature of the invention, the control unit may perform a temperature control to increase a time ratio of the OFF state in controlling the ON and OFF states of the plurality of switch elements when at least one temperature detected at the plurality of temperature detection units is higher than a predetermined temperature.

Another aspect of the invention relates to an electric vehicle, which includes the above-described power supply device, an electric motor that produces mechanical power from electric power supplied by the power supply device, and a drive wheel to which the power generated by the electric motor is transmitted.

### BRIEF DESCRIPTION OF THE DRAWINGS

FIG. 1 is a circuit diagram of a power supply device according to a first embodiment of the present invention.

FIG. 2 is a chart showing a relationship between an amount of current Id and a voltage difference Vd.

FIG. 3 is a chart showing a relationship between an amount of heat J_{L} and an average amount of current I_{AVG}.

FIG. 4 is a diagram showing states of switch elements (FETs 21A/22A to 21C/22C) of FIG. 1.

FIG. 5 is a diagram showing states of switch elements (FETs 21A/22A to 21C/22C) of FIG. 1.

FIG. 6 is a flowchart showing operations of a temperature control of a control unit 50 of FIG. 1.

FIG. 7 is a flowchart showing operations of an alleviating control of the remaining capacity variation of the control unit 50 of FIG. 1.

FIG. 8 is a flowchart showing operations of an alleviating control of the remaining capacity variation of the control unit 50 of FIG. 1.

FIG. 9 is a diagram showing states of switch elements (FETs 21A/22A to 21C/22C) according to a second embodiment.

FIG. 10 is a block diagram of an electric vehicle incorporating the power supply device of FIG. 1, in accordance with another aspect of the invention.

### DETAILED DESCRIPTION OF THE INVENTION

Specific embodiments of the power supply device according to the present invention will be described hereinafter by referring to the drawings. In each of the drawings to be referred to, the same or similar reference numbers are assigned to the same or similar parts.

However, the drawings are provided for explanation only and it should be noted that details such as the ratios of each dimension may differ from reality. Therefore, specific dimensions etc. should be determined by referring to the description below. It also should be noted that there may be parts the dimensional relationships and ratios of which may differ among the drawings.

### First Embodiment

(Structure of the Power Supply Device)

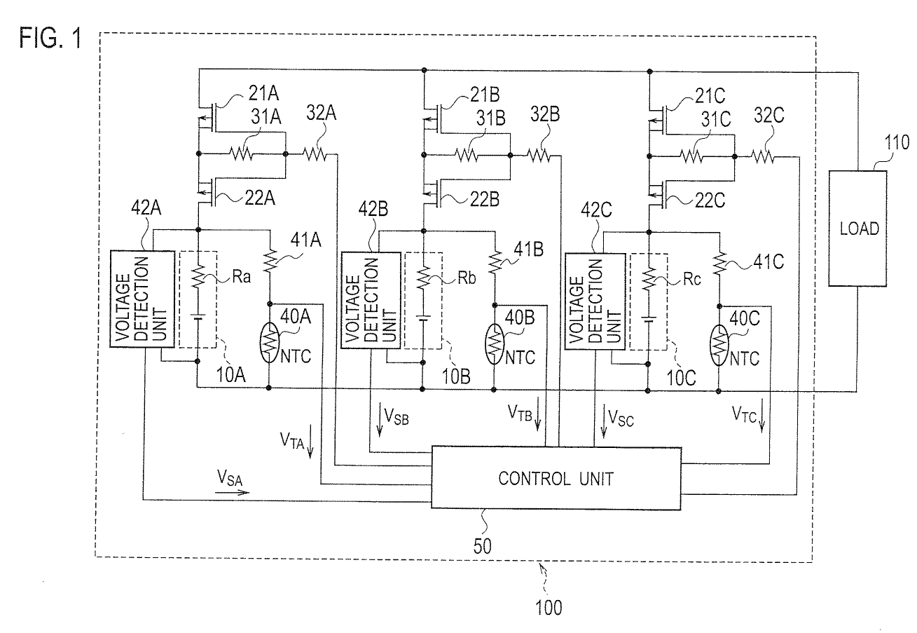

The first embodiment of the power supply device according to the invention now will be described by referring to the drawings below. FIG. 1 is a circuit diagram showing a power supply device 100 according to the first embodiment.

As shown in FIG. 1, the power supply device 100 has a plurality of power storage devices (power storage devices 10A to 10C), a plurality of switch elements (Field-Effect Transistors (FETs) 21A/22A to 21C/22C), a first plurality of resistors (resistors 31A/32A to 31C/32C), a plurality of temperature detection units (NTCs 40A to 40C), a second plurality of resistors (resistors 41A to 41C), a plurality of voltage detection units (voltage detection units 42A to 42C), and a control unit 50.

The power storage devices 10A to 10C are connected in parallel with each other and each of the power storage devices 10A to 10C is connected to a load 110. The power storage devices 10A to 10C respectively have internal resistances Ra to Rc. For example, in a case in which the power supply device 100 is used in an electric vehicle (EV; Electric Vehicle, HEV; Hybrid Electric Vehicle), the load 110 is for example an electric motor provided in the electric vehicle. Here, it should be noted that the circuits of the power storage devices 10A to 10C respectively have similar structures.

The power storage devices 10A to 10C are devices that store electric charge. Positive electrodes of the power storage devices 10A to 10C are connected to drains of the FETs 22A to 22C. Negative electrodes of the power storage devices 10A to 10C are connected to the load 110.

The FETs 21A/22A to 21C/22C are field effect transistors each having a gate, a source, and a drain. The FETs 21A/22A to 21C/22C are connected to the power storage devices 10A to 10C in series, and respectively switch the connection conditions between the power storage devices 10A to 10C and the load 110.

In the first embodiment, if the FETs 21A/22A to 21C/22C are in the ON state, the power storage devices 10A to 10C are connected to the load 110, and if the FETs 21A/22A to 21C/22C are in the OFF state, the power storage devices 10A to 10C are disconnected or separated from the load 110.

The gates of the FETs 21A/22A to 21C/22C are connected to the control unit 50 through the resistors 32A to 32C. The drains of the FETs 21A to 21C are connected to the load 110, and the sources of the FETs 21A to 21C are connected to the sources of the FETs 22A to 22C and one end of respective resistors 31A to 31C. The drains of the FETs 22A to 22C are connected to the positive electrodes of the power storage devices 10A to 10C, and the sources of the FETs 22A to 22C are connected to the sources of the FETs 21A to 21C and one end of respective resistors 31A to 31C.

The NTCs 40A to 40C are thermistors that detect temperatures of the power storage devices 10A to 10C. Here, as an example of a thermistor, a NTC (Negative Temperature Coefficient) thermistor is used. However, a PTC (Positive Temperature Coefficient) thermistor also may be used.

As the temperatures of the NTCs 40A to 40C increase, resistance values of the NTCs 40A to 40C decrease. In addition, the NTCs 40A to 40C are provided in the vicinities of the power storage devices 10A to 10C respectively. In other words, the temperatures of the NTCs 40A to 40C are correlated to the temperatures T1 to T3 of the power storage devices 10A to 10C.

The NTCs 40A to 40C are connected to the drains of the FETs 22A to 22C through the resistors 41A to 41C, and are connected in parallel with the power storage devices 10A to 10C. The resistances values of the NTCs 40A to 40C are obtained from voltages V_{T1} to V_{T3} applied to the NTCs 40A to 40C, and the temperatures of the NTCs 40A to 40C (that is, the temperatures T1 to T3 of the power storage devices 10A to 10C) are obtained from the resistance values of the NTCs 40A to 40C.

The voltage detection units 42A to 42C are provided in parallel with the power storage devices 10A to 10C, and detects the voltages V_{SA} to V_{SC} at both ends of the power storage devices 10A to 10C. The values of the voltages V_{SA} to V_{SC} are correlated to the remaining capacities of the power storage devices 10A to 10C. Therefore, the remaining capacities of the power storage devices 10A to 10C can be compared based on the voltages V_{SA} to V_{SC}.

The control unit 50 performs a temperature control for increasing the time ratio of the OFF state in the control of the ON and OFF states of the switch elements (FETs 21A/22A to 210/220) based on the temperatures of the power storage devices 10A to 10C. In particular, the control unit 50 measures the temperatures of the power storage devices 10A to 10C from the voltages V_{T1} to V_{T3} applied to the NTCs 40A to 40C. Subsequently, the control unit 50 performs a duty ratio control to decrease the duty ratios D1 to D3 of the power storage devices 10A to 10C respectively when the temperatures of the power storage devices 10A to 10C become higher than a predetermined temperature TH. Alternatively, the control unit 50 may perform a duty ratio control to adjust the duty ratios D1 to D3 when a difference in the temperatures of the power storage devices 10A to 10C is higher than a predetermined value.

The time ratio of the OFF state is a ratio of time in which the OFF state of the switch element occupies in unit time. Similarly, the duty ratios D1 to D3 are ratios in which the power storage devices 10A to 10C are connected to the load 110 in unit time. In other words, the duty ratios D1 to D3 are ratios of time in which the ON state of the switch elements occupy in unit time. Also, the predetermined temperature TH is preferably a temperature that is lower than an allowable temperature established in order to utilize the power storage devices 10A to 10C safely. For example, if the allowable temperature of the power storage devices 10A to 10C is 80° C., the predetermined temperature TH can be set as 70° C.

Here, when such a temperature control is performed, there may be a case in which remaining capacities of the power storage devices 10A to 10C may vary amongst each other. In this embodiment, the control unit 50 performs an “alleviating control of the remaining capacity variation” for alleviating the remaining capacity variation by charging from a power storage device 10_{MAX} having the highest remaining capacity to a power storage device 10_{MIN} having the lowest remaining capacity.

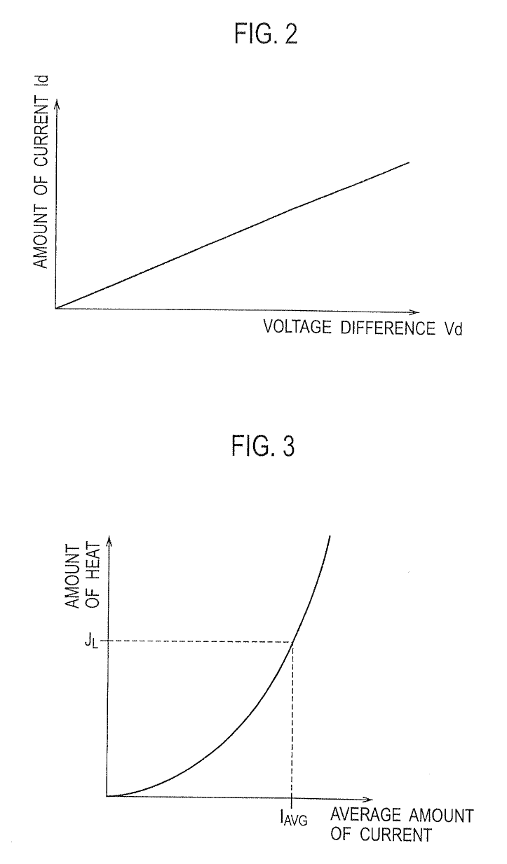

In particular, the control unit 50 obtains the voltages V_{SA} to V_{SC} that are detected at the voltage detection units 42A to 42C. Each of the voltages V_{SA} to V_{SC} is an open voltage of each power storage device 10A to 10C. The control unit 50 computes a voltage difference between the highest voltage V_{SMAX} and the lowest voltage V_{SMIN} among the voltages V_{SA} to V_{SC} . Based on the voltage difference Vd, the control unit 50 computes an amount of current Id that flows from the power storage device 10_{MAX} to the power storage device 10_{MIN} when the power storage device 10_{MAX} and the power storage device 10_{MIN} are connected. The amount of current Id is in a proportional relation with the voltage difference Vd as shown in FIG. 2.

Here, the control unit 50 memorizes in advance a limit heat amount J_{L} having a value that does not affect the temperatures of the power storage devices 10A to 10C (that is, an extent that does not increase the temperatures of the power storage devices 10A to 10C) when applied to the power storage devices 10A to 10C. Also, the control unit 50 memorizes an average amount of current I_{AVG} that generates the limit heat amount J_{L}. The heat amount J_{L} and the average amount of current I_{AVG} have a relationship of J_{L}=R×I_{AVG}² (in which R is an internal resistance Ra to Rc) as shown in FIG. 3. The average amount of current I_{AVG} is an amount of current having a value that does not affect the temperatures of the power storage devices 10A to 10C.

Next, the control device 50 sets a connecting time period for electrically connecting the power storage device 10_{MAX} and the power storage device 10_{MIN} by having the power storage device 10_{MAX} and the power storage device 10_{MIN} switched in the ON state at the same time. In particular, the control unit 50 computes a duty ratio Don such that the amount of current Id becomes equal to the average amount of current I_{AVG}. The duty ratio Don is a time ratio of the connecting time relative to unit time.

Next, the control unit 50 periodically connects the power storage device 10_{MAX} and the power storage device 10_{MIN} with the duty ratio of Don while performing a temperature control.

As an example of the alleviating control of the remaining capacity variation, an instance will be explained in which the relationship among the duty ratios D1 to D3 of the power storage devices 10A to 10C is D2<D1<D3, and the power storage device 10B corresponds to the power storage device 10_{MAX} and the power storage device 10C corresponds to the power storage device 10_{MIN}.

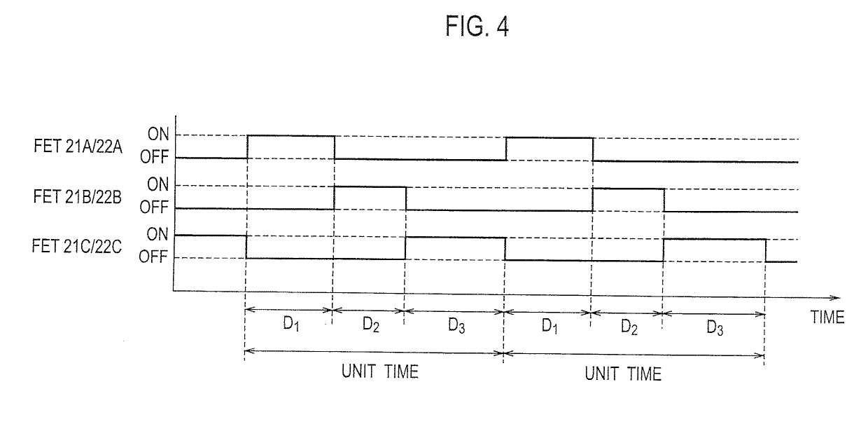

As shown in FIG. 4, the control unit 50 performs a temperature control of the power storage devices 10A to 10C by switching the switch elements (FETs 21A/22A to 21C/22C) in the ON state at a time ratio of the duty ratios D1 to D3.

The control unit 50 computes a voltage difference Vd_{BC} between the highest voltage V_{SB} and the lowest voltage V_{SC} based on the voltages V_{SA} to V_{SC} detected at the voltage detection units 42A to 42C. Based on the voltage difference Vd_{BC}, the control unit 50 computes an amount of current Id_{BC} that flows from the power storage device 10B to the power storage device 10C when the power storage device 10B and the power storage device 10C are connected.

Next, the control unit 50 computes the duty ratio Don such that the amount of current Id_{BC} becomes equal to the average amount of current I_{AVG}.

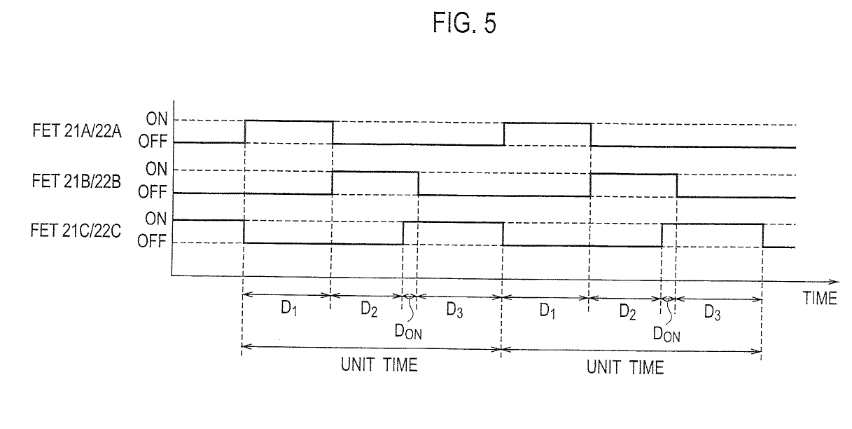

Next, the control unit 50 modifies the duty ratio for the power storage device 10B from D2 to D2+Don, and modifies the duty ratio for the power storage device 10C from D3 to D3+Don. Thus, the FETs 21B/22B are in the ON state with the time ratio of the duty ratio D2+Don, and the FETs 21C/22C are in the ON state with the time ratio of the duty ratio D3+Don. Here, as shown in FIG. 5, the control unit 50 makes the FETs 21B/22B and the FETs 21C/22C in the ON state at the same time during the connecting period of the duty ratio Don. Therefore, the power storage device 10B and the power storage device 10C are connected with each other with the duty ratio of Don while the temperature control is performed.

(Operations of the Power Supply Device)

Operations of the power supply device concerning the first embodiment will be described by referring to the drawings below.

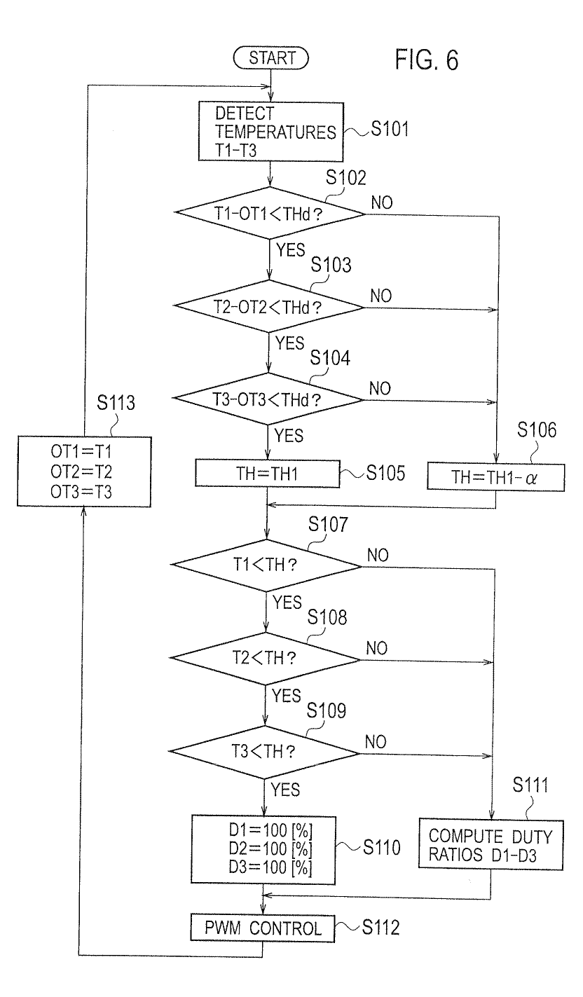

FIG. 6 is a flowchart showing operations of a temperature control of the power supply device 100 (the control unit 50) according to the first embodiment.

First, at the time of starting the process, the control unit 50 registers the present temperatures T1 to T3 as past temperature data OT1 to OT3 of the power storage devices 10A to 10C, and the process advances to step S101.

At step S101, the control unit 50 obtains values of the temperatures T1 to T3. At steps S102 to S104, the control unit 50 computes the differences between the obtained temperatures T1 to T3 and the past temperature data OT1 to OT3 respectively and compares the respective differences with a threshold value THd that denotes a predetermined temperature width. As a result of the comparisons, if all of the differences are smaller than the threshold value THd, the process advances to step S105. On the other hand, if at least one of the differences is greater than the threshold value THd, the process advances to step S106.

At steps S105 and S106, the control unit 50 sets a predetermined temperature TH for starting a current limitation control with respect to the power storage devices 10A to 10C based on the above-described temperature differences. At step S105, the control unit 50 determines that steep temperature change did not occur, and sets a predetermined trip temperature TH1 as a threshold value TH and advances the process to step S107. At step S106, the control unit 50 determines that steep temperature change occurred, and sets a value in which a given temperature a is subtracted from the predetermined trip temperature TH1 as a threshold value TH and advances the process to step S107.

At steps S107 to S109, the control unit 50 compares the temperature TH determined at step S105 or step S106 and the present temperatures T1 to T3. If all of the present temperatures T1 to T3 are lower than the threshold value TH, the process advances to step S110. On the other hand, if at least one of the present temperatures T1 to T3 is higher than the temperature TH, the process advances to step S111.

At step S110, the control unit 50 determines that the temperatures T1 to T3 are sufficiently low, and at step S112, the control unit 50 performs a PWM control on each switch element by setting all of the duty ratios D1 to D3 of the switch elements corresponding to the power storage devices 10A to 10C respectively as 100% (i.e. no current limitation control is performed).

At step S111, the control unit 50 determines that the temperatures T1 to T3 are high, and computes the duty ratios D1 to D3. At step S112, the control unit 50 performs a PWM control on each switch element by utilizing the computed duty ratios D1 to D3. Then the process advances to step S113. At step S113, the temperatures T1 to T3 are allocated as the past temperature data OT1 to OT3 respectively, and the process returns to step S101.

Now, one example of a computation method of the duty ratios D1 to D3 at step S111 will be described. To obtain the duty ratios D1 to D3, the values of the temperatures T1 to T3 are compared and the lowest temperature TS is obtained, and the duty ratios D1 to D3 are obtained by setting the lowest temperature TS as the numerator and the temperature T1 to T3 of each power storage device as the denominator. In other words, the duty ratios D1 to D3 are: D1=TS/T1, D2=TS/T2, and D3=TS/T3. In addition, when setting the duty ratios as such, the duty ratio of the power storage device having the lowest temperature is 100%, and the duty ratios D for the other power storage devices 10 become a value that is less than 100%.

In particular, when T1<T2<T3=60° C.<70° C.<80° C., the duty ratio D1 is 60/60×100=100%; the duty ratio D2 is 60/70×100≈86%; and the duty ratio D3 is 60/80×100=75%.

While the duty ratios D1 to d3 were computed from the variations of the temperatures T1 to T3 at step S111, the duty ratios D1 to D3 also may be computed individually for each power storage device.

At the time when the control unit 50 returns the process from step S112 back to step S101, a wait step may be inserted to wait for a predetermined time. Such a predetermined time may differ depending on the power storage device and temperature change tendency of the power supply device 210 for example. If the temperature change tendency is small, it is preferable to set the predetermined time longer.

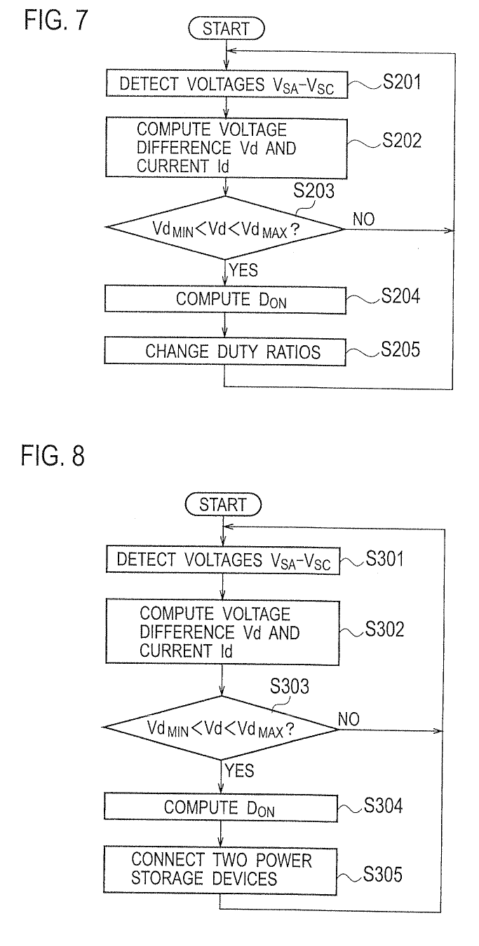

FIG. 7 is a flowchart showing operations of an alleviating control of the remaining capacity variation of the power supply device 100 (the control unit 50) according to the first embodiment.

At step S201, the control unit 50 obtains the voltages V_{SA} to V_{SC} detected at the voltage detection units 42A to 42C.

At step S202, the control unit 50 computes the voltage difference Vd between the highest voltage V_{SMAX} and the lowest voltage V_{SMIN} among the voltages V_{SA} to V_{SC} and the amount of current Id.

At step S203, the control unit 50 determines whether or not the voltage difference Vd is a value within a given range. More specifically, it is determined whether or not the voltage difference Vd is a value that is greater than a lowest voltage difference Vd_{MIN} detectable at the control unit 50 and is lower than a highest voltage difference Vd_{MAX} that produces a current amount that generates a heat amount that exceeds the limit heat amount J_{L}. If the voltage difference Vd is a value within the given range, the process advances to step S204. If the voltage difference is not a value within the given range, the process returns to step S201.

At step S204, the control unit 50 computes a duty ratio Don, which is a connecting time period per unit time, based on the amount of current Id and the average amount of current I_{AVG} that generates the limit heat amount J_{L}, such that the amount of current Id and the average amount of current I_{AVG} become equal.

At step S205, the control unit 50 changes the duty ratios D1 to D3 obtained at the above-described temperature control. In particular, the control unit 50 adds the duty ratio Don to the duty ratio of the power storage device 10_{MAX} for which the highest voltage V_{SMAX} was detected and to the duty ratio of the power storage device 10_{MIN} for which the lowest voltage V_{SMIN} was detected. As such, the power storage device 10_{MAX} and the power storage device 10_{MIN} are mutually connected at the duty ratio Don while the temperature control is performed.

(Operations and Effects)

In the first embodiment, the control unit 50 performs the temperature control to increase the time ratio of the OFF state in controlling the ON and OFF states of the FETs 21A/22A to FETs 21C/22C when at least one of the temperatures detected at the NTCs 40A to 40C exceeds a predetermined temperature TH.

Therefore, it becomes possible to restrain temperatures of the power storage devices 10A to 10C from becoming higher than the predetermined temperature TH. Accordingly, the occurrence of temperature variation among the power storage devices 10A to 10C can be restrained. As a result, the degree of deterioration of each of the power storage device 10A to 10C can be reduced and thus the operating life duration of the power supply device 210 can be extended.

Also, the control unit 50 sets a connecting time period for electrically connecting two power storage devices among the power storage devices 10A to 10C based on the voltages V_{SA} to V_{SC} detected at the voltage detection units 42A to 42C. In particular, the control unit 50 computes the duty ratio Don which is a connecting time period per unit time, based on the voltage difference Vd of the two storage devices and the average amount of current I_{AVG} that does not affect the temperatures of the power storage devices 10A to 10C.

Therefore, when variation occurs in the respective remaining capacities of the two power storage devices by performing the temperature control, it is possible to charge from one power storage device to another power storage device by setting the connecting time period to electrically connect the two power storage devices. As a result, variation in the remaining capacities that occurred between the two power storage devices can be alleviated.

The two power storage devices are a power storage device 10_{MAX} having the highest remaining capacity and a power storage device 10_{MIN} having the lowest remaining capacity among the power storage devices 10A to 10C. Therefore, since charging can be performed rapidly between the two power storage devices, variation in the remaining capacities can be alleviated effectively.

### Second Embodiment

Now a power supply device according to the second embodiment of the invention will be described by referring to the drawings. The differences with the first embodiment will be primarily described below. In particular, in the second embodiment, the power supply device 100 (control unit 50) performs an alleviating control of the remaining capacity variation when the power supply device 100 and the load 110 are not electrically connected.

FIG. 8 is a flowchart showing operations of an alleviating control of the remaining capacity variation of the control unit 50 of FIG. 1 according to the second embodiment.

At step 301, the control unit 50 obtains the voltages V_{SA} to V_{SC} detected at the voltage detection units 42A to 42C.

At step S302, the control unit 50 computes the voltage difference Vd between the highest voltage V_{SMAX} and the lowest voltage V_{SMIN} among the voltages V_{SA} to V_{SC} and the amount of current Id.

At step S303, the control unit 50 determines whether or not the voltage difference Vd is a value within a given range. If the voltage difference Vd is a value within the given range, the process advances to step S304. If the voltage difference is not a value within the given range, the process returns to step S301.

At step S304, the control unit 50 computes a duty ratio Don, which is a connecting time period per unit time, based on the amount of current Id and the average amount of current I_{AVG}.

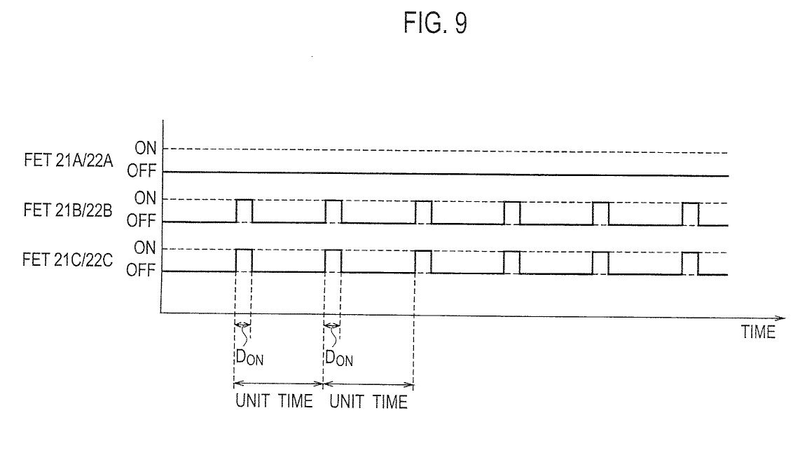

At step S305, the control unit 50 electrically connects the two power storage devices with the duty ratio Don when the load 110 is not electrically connected as shown in FIG. 9. FIG. 9 shows a case in which the power storage device 10B is the power storage device 10_{MAX} having the highest remaining capacity and the power storage device 10C is the power storage device 10_{MIN} having the lowest remaining capacity.

(Operation and Effects)

In the second embodiment, the control unit 50 electrically connects the two power storage devices with the duty ratio Don when the load 110 is not electrically connected. Therefore, no current flows from the power storage device 10_{MAX} to the load. Accordingly, since a constant current can flow from the power storage device 10_{MAX} having the highest remaining capacity to the power storage device 10_{MIN} having the lowest remaining capacity, variation in the remaining capacities can be alleviated effectively.

### Third Embodiment

Now the third embodiment of the invention will be described. In the third embodiment, an electric vehicle in which the above-described power supply device 100 is provided will be described.

(Structure of the Electric Vehicle)

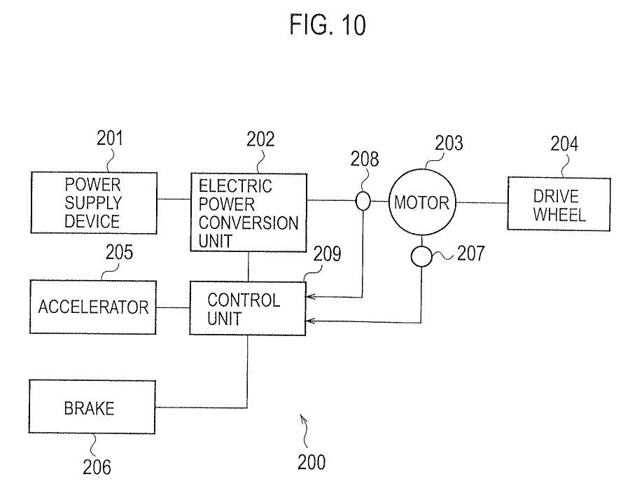

Now the electric vehicle according to the third embodiment will be described by referring to the drawings below. FIG. 10 is a view showing an electric vehicle 200 according to the third embodiment.

As shown in FIG. 10, the electric vehicle 200 includes a power supply device 201, a power conversion unit 202, a motor 203, drive wheels 204, an accelerator 205, a brake 206, a rotation sensor 207, a current sensor 208, and a control unit 209.

The power supply device 201 is the power supply device 100 as described above. That is, the power supply device 201 includes the power storage device 10 that are connected in parallel.

The power conversion unit 202 converts the electric power from the power supply device 201 to electric power required by the motor 203 according to an operation of the motor 203. Also, in a case that the motor 203 performs regeneration, the power conversion unit 202 converts the electric power from the motor 203 to electric power to be stored in the power supply device 201 according to an operation of the motor 203.

The motor 203 generates torque by the electric power converted by the power conversion unit 202. The torque generated by the motor 203 is transmitted to the drive wheels 204.

The drive wheels 204 are the wheels connected to the motor 203 among the wheels provided in the electric vehicle 200.

The accelerator 205 is a mechanism to increase the rotation speed of the motor 203. The brake 206 is a mechanism to decrease the rotation speed of the motor 203.

The rotation sensor 207 detects the rotation speed of the motor 203. The current sensor 208 detects the current value supplied to the motor 203.

The control unit 209 computes command torque based on the information obtained from the accelerator 205 and the rotation sensor 207 etc. The control unit 209 computes a current command value based on the command torque. The control unit 209 controls the power conversion unit 202 based on the difference between the current value obtained from the current sensor 208 and the current command value. With this, the control unit 209 controls the rotation speed of the motor 203. In addition, the control unit 209 controls power regeneration of the motor 203 based on information obtained from the brake 206 etc.

### Other Embodiments

While the thermistor was illustrated as the temperature detection unit in the above-described embodiments, the temperature detection unit is not limited to the thermistor.

While the FET was illustrated as the switch element in the above-described embodiments, the switch element is not limited to the FET. For example, the switch element also may be a bipolar transistor.

In the above-described embodiments, the circuit structure of the power supply device 100 was only illustrative, and the circuit structure of the power supply device 100 may be modified accordingly.

According to the present invention, it is possible to provide a power supply device and an electric vehicle in which variation in the respective remaining capacities among a plurality of power storage devices can be reduced.

The present invention may be embodied in other specific forms without departing from the spirit or essential characteristics thereof. The embodiments are therefore to be considered in all respects as illustrative and not restrictive, the scope of the present invention being indicated by the appended claims rather than by the foregoing description, and all changes that come within the meaning and range of equivalency of the claims therefore are intended to be embraced therein.

What is claimed is:

1. A power supply device having a plurality of power storage devices connected in parallel with each other, comprising:
a plurality of temperature detection units for respectively detecting temperatures of the plurality of power storage devices;
a plurality of voltage detection units for respectively detecting voltages applied to the plurality of power storage devices;
a plurality of switch elements respectively connected in series with the plurality of power storage devices;
a control unit for controlling the ON and OFF states of the plurality of switch elements based on the temperatures detected at the plurality of temperature detection units,
wherein the control unit sets a connecting time period for electrically connecting two power storage devices among the plurality of power storage devices based on the voltages detected at the plurality of voltage detection units.

2. The power supply device of claim 1,
wherein the control unit computes the connecting time period per unit time based on a voltage difference of the two power storage devices and a predetermined amount of current that does not affect temperatures of the plurality of power storage devices.

3. The power supply device of claim 1,
wherein a voltage of one of the two power storage devices is the lowest voltage among the respective voltages of the plurality of power storage devices.

4. The power supply device of claim 1,
wherein a voltage of one of the two power storage devices is the highest voltage among the voltages of the plurality of power storage devices.

5. The power supply device of claim 1,
wherein the control unit performs a temperature to increase a time ratio of the OFF state in controlling the ON and OFF states of the plurality of switch elements when at least one temperature detected at the plurality of temperature detection units is higher than a predetermined temperature.

6. An electric vehicle, comprising:
the power supply device of claim 1;
an electric motor for producing mechanical power from electric power supplied by the power supply device;
a drive wheel to which the power generated by the electric motor is transmitted.
